(19) United States
(12) Patent Application Publication
(10) Pub. No.: US 2022/0358877 A1
(43) Pub. Date: Nov. 10, 2022

(54) Adaptive Display

(71) Applicant: Universal Display Corporation, Ewing, NJ (US)

(72) Inventors: Michael HACK, Carmel, CA (US); Michael Stuart WEAVER, Princeton, NJ (US)

(21) Appl. No.: 17/738,470

(22) Filed: May 6, 2022

Related U.S. Application Data
(60) Provisional application No. 63/185,460, filed on May 7, 2021.

(51) Int. Cl. G09G 3/3208; G06F 3/01; G06V 40/16; G06V 10/82

(52) U.S. Cl. CPC G09G 3/3208; G06F 3/013; G06V 40/161; G06V 10/82; G09G 2320/106; G09G 2320/0666; G09G 2340/0435; G09G 2360/144; G09G 2320/0613

(57) ABSTRACT

Adaptive display devices and techniques for operating the same are provided. A secondary display processor analyzes incoming display signals to identify characteristics of the display signal and provide display panel behavior adjustment data that is used to change the behavior of a display panel based on the contents of the display signal. The secondary processor may implement one or more machine learning algorithms to identify the display signal characteristics and to generate the display panel behavior adjustment data.

### CROSS-REFERENCE TO RELATED APPLICATIONS

This application is a non-provisional of, and claims the priority benefit of U.S. Provisional Patent Application Ser. No. 63/185,460, filed May 7, 2021 the entire contents of which are incorporated herein by reference.

### FIELD

The present invention relates to adaptive display panels and techniques for operating the same, which may include panels formed from organic light emitting diodes, and devices and techniques including the same.

### BACKGROUND

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting diodes/devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety.

One application for phosphorescent emissive molecules is a full color display. Industry standards for such a display call for pixels adapted to emit particular colors, referred to as “saturated” colors. In particular, these standards call for saturated red, green, and blue pixels. Alternatively the OLED can be designed to emit white light. In conventional liquid crystal displays emission from a white backlight is filtered using absorption filters to produce red, green and blue emission. The same technique can also be used with OLEDs. The white OLED can be either a single EML device or a stack structure. Color may be measured using CIE coordinates, which are well known to the art.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

As used herein, “top” means furthest away from the substrate, while “bottom” means closest to the substrate. Where a first layer is described as “disposed over” a second layer, the first layer is disposed further away from substrate. There may be other layers between the first and second layer, unless it is specified that the first layer is “in contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

A ligand may be referred to as “photoactive” when it is believed that the ligand directly contributes to the photoactive properties of an emissive material. A ligand may be referred to as “ancillary” when it is believed that the ligand does not contribute to the photoactive properties of an emissive material, although an ancillary ligand may alter the properties of a photoactive ligand.

As used herein, and as would be generally understood by one skilled in the art, a first “Highest Occupied Molecular Orbital” (HOMO) or “Lowest Unoccupied Molecular Orbital” (LUMO) energy level is “greater than” or “higher than” a second HOMO or LUMO energy level if the first energy level is closer to the vacuum energy level. Since ionization potentials (IP) are measured as a negative energy relative to a vacuum level, a higher HOMO energy level corresponds to an IP having a smaller absolute value (an IP that is less negative). Similarly, a higher LUMO energy level corresponds to an electron affinity (EA) having a smaller absolute value (an EA that is less negative). On a conventional energy level diagram, with the vacuum level at the top, the LUMO energy level of a material is higher than the HOMO energy level of the same material. A “higher” HOMO or LUMO energy level appears closer to the top of such a diagram than a “lower” HOMO or LUMO energy level.

As used herein, and as would be generally understood by one skilled in the art, a first work function is “greater than” or “higher than” a second work function if the first work function has a higher absolute value. Because work functions are generally measured as negative numbers relative to vacuum level, this means that a “higher” work function is more negative. On a conventional energy level diagram, with the vacuum level at the top, a “higher” work function is illustrated as further away from the vacuum level in the downward direction. Thus, the definitions of HOMO and LUMO energy levels follow a different convention than work functions.

Layers, materials, regions, and devices may be described herein in reference to the color of light they emit. In general, as used herein, an emissive region that is described as producing a specific color of light may include one or more emissive layers disposed over each other in a stack.

As used herein, a “red” layer, material, region, or device refers to one that emits light in the range of about 580-700 nm or having a highest peak in its emission spectrum in that region. Similarly, a “green” layer, material, region, or device refers to one that emits or has an emission spectrum with a peak wavelength in the range of about 500-600 nm; a “blue” layer, material, or device refers to one that emits or has an emission spectrum with a peak wavelength in the range of about 400-500 nm; and a “yellow” layer, material, region, or device refers to one that has an emission spectrum with a peak wavelength in the range of about 540-600 nm. In some arrangements, separate regions, layers, materials, regions, or devices may provide separate “deep blue” and a “light blue” light. As used herein, in arrangements that provide separate “light blue” and “deep blue”, the “deep blue” component refers to one having a peak emission wavelength that is at least about 4 nm less than the peak emission wavelength of the “light blue” component. Typically, a “light blue” component has a peak emission wavelength in the range of about 465-S00 nm, and a “deep blue” component has a peak emission wavelength in the range of about 400-470 nm, though these ranges may vary for some configurations. Similarly, a color altering layer refers to a layer that converts or modifies another color of light to light having a wavelength as specified for that color. For example, a “red” color filter refers to a filter that results in light having a wavelength in the range of about 580-700 nm. In general, there are two classes of color altering layers: color filters that modify a spectrum by removing unwanted wavelengths of light, and color changing layers that convert photons of higher energy to lower energy. A component “of a color” refers to a component that, when activated or used, produces or otherwise emits light having a particular color as previously described. For example, a “first emissive region of a first color” and a “second emissive region of a second color different than the first color” describes two emissive regions that, when activated within a device, emit two different colors as previously described.

As used herein, emissive materials, layers, and regions may be distinguished from one another and from other structures based upon light initially generated by the material, layer or region, as opposed to light eventually emitted by the same or a different structure. The initial light generation typically is the result of an energy level change resulting in emission of a photon. For example, an organic emissive material may initially generate blue light, which may be converted by a color filter, quantum dot or other structure to red or green light, such that a complete emissive stack or sub-pixel emits the red or green light. In this case the initial emissive material or layer may be referred to as a “blue” component, even though the sub-pixel is a “red” or “green” component.

In some cases, it may be preferable to describe the color of a component such as an emissive region, sub-pixel, color altering layer, or the like, in terms of 1931 CIE coordinates. For example, a yellow emissive material may have multiple peak emission wavelengths, one in or near an edge of the “green” region, and one within or near an edge of the “red” region as previously described. Accordingly, as used herein, each color term also corresponds to a shape in the 1931 CIE coordinate color space. The shape in 1931 CIE color space is constructed by following the locus between two color points and any additional interior points. For example, interior shape parameters for red, green, blue, and yellow may be defined as shown below:

| Color | CIE Shape Parameters |
|---|---|
| Central Red | Locus: [0.6270,0.3725];[0.7347,0.2653]; |
| | lnterior:[0.5086,0.2657] |
| Central Green | Locus: [0.0326,0.3530];[0.3731,0.6245]; |
| | lnterior:[0.2268,0.3321 |
| Central Blue | Locus: [0.1746,0.0052];[0.0326,0.3530]; |
| | lnterior:[0.2268,0.3321] |
| Central Yellow | Locus: [0.373 l,0.6245];[0.6270,0.3725]; |
| | Interior: [0.3 700,0.4087];[0.2886,0.4572] |

More details on OLEDs, and the definitions described above, can be found in U.S. Pat. No. 7,279,704, which is incorporated herein by reference in its entirety.

### SUMMARY

According to an embodiment, an organic light emitting diode/device (OLED) is also provided. The OLED can include an anode, a cathode, and an organic layer, disposed between the anode and the cathode. According to an embodiment, the organic light emitting device is incorporated into one or more device selected from a consumer product, an electronic component module, and/or a lighting panel.

According to an embodiment, a display device includes a display panel; a first processor in signal communication with the display panel, the first processor configured to receive an input display signal and provide image data to the display panel; and a second processor configured to receive the input display signal and provide display panel behavior adjustment data to the display processor based on the input display signal, the display panel behavior adjustment data indicating a first adjustment to an operational behavior of the display panel based on a first characteristic of the input display signal. The first processor, the second processor, or a combination thereof may be configured to alter the operational behavior of the display panel based on the display panel behavior adjustment data. The first characteristic of the input display signal may include brightness, frame rate, color gamut, color saturation, hue, white point and resolution, a movement speed of an object; a relative brightness of an object; a static icon; a degree of detail; a face; an artificial image, or any combination thereof. The adjustment to the operational behavior of the display panel may include changing a white point color temperature; a color gamut; a display frame rate; a green to blue ratio or a red to green ratio; a luminance; a blue saturation, or any combination thereof. The first adjustment to the operational behavior of the display panel based on the first characteristic of the input display signal may include lowering a blue saturation based on a luminance being over a threshold; lowering a white point color temperature based on a luminance being over a threshold; lowering a blue saturation based on a detection of a static icon; reducing a display frame rate based on video content having movement from frame to frame below a threshold; increasing a display frame rate based on video content having movement from frame to frame above a threshold; increasing a display resolution based on video content having a detail level over a threshold; adjusting a white point color temperature, a color gamut, a blue content, or a combination thereof based on detecting one or more faces; decreasing a blue saturation, a white point color temperature, or a combination thereof based on detecting artificial image data; or any combination thereof. The second processor may include an artificial intelligence processor, for example to implement a machine learning system that applies a machine learning algorithm to the input display signal to generate the image adjustment data. The machine learning system may include a neural network, a convolution neural network, a recurrent neural network, a radial basis function neural network, a multilayer perceptron, a deep belief network, or any combination thereof.

The device may further include a sensor such as an ambient light sensor or any other suitable sensor, with the first and/or second processor being configured to adjust the operational behavior of the display panel based data from the sensor, such as adjusting the behavior based on a brightness of ambient light detected by an ambient light sensor. The sensor also may include a gaze detection sensor configured to identify a direction of gaze of a viewer of the display, with the first processor being configured to adjust the operational behavior of the display panel based on the direction of gaze detected by the gaze detection sensor. The sensor may include an infrared (IR) sensor, a still camera, a video camera, or any combination thereof.

The display panel may include an organic light emitting device (OLED) display, a light emitting diode (LED) or micro-LED display, a quantum dot-based display, a liquid crystal display (LCD), or a combination thereof.

The device may be at least one type selected from the group consisting of: a flat panel display, a curved display, a computer monitor, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a cell phone, tablet, a phablet, a personal digital assistant (PDA), a wearable device, a laptop computer, a digital camera, a camcorder, a viewfinder, a micro-display that is less than 2 inches diagonal, a 3-D display, a virtual reality or augmented reality display, a vehicle, a video walls comprising multiple displays tiled together, a theater or stadium screen, and a sign.

According to an embodiment, a method is provided of operating a device as previously disclosed, which includes receiving, by a first processor in a display device, an input display signal; generating, by a second processor in the display device, display panel behavior adjustment data, the display panel behavior adjustment data indicating a first adjustment to an operational behavior of a display panel based on a first characteristic of the input display signal; providing the display panel behavior adjustment data to the first processor; adjusting, by the first processor, the operational behavior of the display panel based on the display panel behavior adjustment data; and displaying, by the display panel, the input display signal.

### BRIEF DESCRIPTION OF THE DRAWINGS

FIG. 1 shows an organic light emitting device.

FIG. 2 shows an inverted organic light emitting device that does not have a separate electron transport layer.

FIG. 3 shows a schematic representation of an adaptive display panel system as disclosed herein.

### DETAILED DESCRIPTION

Generally, an OLED comprises at least one organic layer disposed between and electrically connected to an anode and a cathode. When a current is applied, the anode injects holes and the cathode injects electrons into the organic layer(s). The injected holes and electrons each migrate toward the oppositely charged electrode. When an electron and hole localize on the same molecule, an “exciton,” which is a localized electron-hole pair having an excited energy state, is formed. Light is emitted when the exciton relaxes via a photoemissive mechanism. In some cases, the exciton may be localized on an excimer or an exciplex. Non-radiative mechanisms, such as thermal relaxation, may also occur, but are generally considered undesirable.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 3, 4-6 (1999) (“Baldo-II”), are incorporated by reference in their entireties. Phosphorescence is described in more detail in U.S. Pat. No. 7,279,704 at cols. 5-6, which are incorporated by reference.

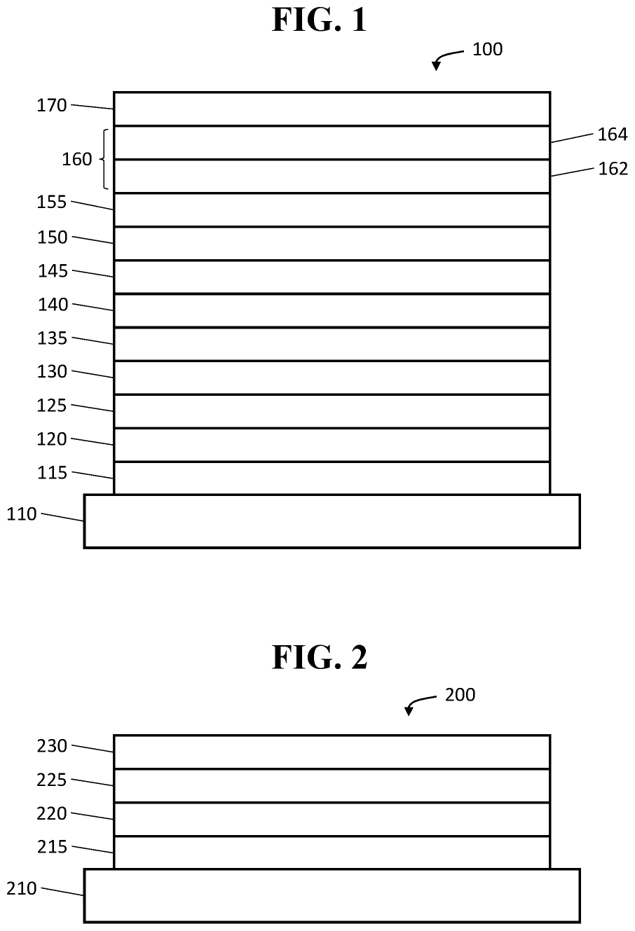

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, a cathode 160, and a barrier layer 170. Cathode 160 is a compound cathode having a first conductive layer 162 and a second conductive layer 164. Device 100 may be fabricated by depositing the layers described, in order. The properties and functions of these various layers, as well as example materials, are described in more detail in U.S. Pat. No. 7,279,704 at cols. 6-10, which are incorporated by reference.

More examples for each of these layers are available. For example, a flexible and transparent substrate-anode combination is disclosed in U.S. Pat. No. 5,844,363, which is incorporated by reference in its entirety. An example of a p-doped hole transport layer is m-MTDATA doped with F₄-TCNQ at a molar ratio of 50:1, as disclosed in U.S. Patent Application Publication No. 2003/0230980, which is incorporated by reference in its entirety. Examples of emissive and host materials are disclosed in U.S. Pat. No. 6,303,238 to Thompson et al., which is incorporated by reference in its entirety. An example of an n-doped electron transport layer is BPhen doped with Li at a molar ratio of 1:1, as disclosed in U.S. Patent Application Publication No. 2003/0230980, which is incorporated by reference in its entirety. U.S. Pat. Nos. 5,703,436 and 5,707,745, which are incorporated by reference in their entireties, disclose examples of cathodes including compound cathodes having a thin layer of metal such as Mg:Ag with an overlying transparent, electrically-conductive, sputter-deposited ITO layer. The theory and use of blocking layers is described in more detail in U.S. Pat. No. 6,097,147 and U.S. Patent Application Publication No. 2003/0230980, which are incorporated by reference in their entireties. Examples of injection layers are provided in U.S. Patent Application Publication No. 2004/0174116, which is incorporated by reference in its entirety. Barrier layer 170 may be a single- or multi-layer barrier and may cover or surround the other layers of the device. The barrier layer 170 may also surround the substrate 110, and/or it may be arranged between the substrate and the other layers of the device. The barrier also may be referred to as an encapsulant, encapsulation layer, protective layer, or permeation barrier, and typically provides protection against permeation by moisture, ambient air, and other similar materials through to the other layers of the device. Examples of barrier layer materials and structures are provided in U.S. Pat. Nos. 6,537,688, 6,597,111, 6,664,137, 6,835,950, 6,888,305, 6,888,307, 6,897,474, 7,187,119, and 7,683,534, each of which is incorporated by reference in its entirety.

FIG. 2 shows an inverted OLED 200. The device includes a substrate 210, a cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that embodiments of the invention may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one embodiment, an OLED may be described as having an “organic layer” disposed between a cathode and an anode. This organic layer may comprise a single layer, or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190 to Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

In some embodiments disclosed herein, emissive layers or materials, such as emissive layer 135 and emissive layer 220 shown in FIGS. 1-2, respectively, may include quantum dots. An “emissive layer” or “emissive material” as disclosed herein may include an organic emissive material and/or an emissive material that contains quantum dots or equivalent structures, unless indicated to the contrary explicitly or by context according to the understanding of one of skill in the art. In general an emissive layer contains emissive material within a host matrix. Such an emissive layer may include only a quantum dot material which converts light emitted by a separate emissive material or other emitter, or it may also include the separate emissive material or other emitter, or it may emit light itself directly from the application of an electric current. Similarly, a color altering layer, color filter, upconversion, or downconversion layer or structure may include a material containing quantum dots, though such layer may not be considered an “emissive layer” as disclosed herein. In general, an “emissive layer” or material is one that emits an initial light based on injected electrical charge, which may be altered by another layer such as a color filter or other color altering layer that does not itself emit an initial light within the device, but may re-emit altered light of a different spectra content based upon absorption of the initial light emitted by the emissive layer and downconversion to lower energy light emission.

Unless otherwise specified, any of the layers of the various embodiments may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. Pat. No. 7,431,968, which is incorporated by reference in its entirety. Other suitable deposition methods include spin coating and other solution based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as ink-jet and OVJD. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processibility than those having symmetric structures, because asymmetric materials may have a lower tendency to recrystallize. Dendrimer substituents may be used to enhance the ability of small molecules to undergo solution processing.

Devices fabricated in accordance with embodiments of the present invention may further optionally comprise a barrier layer. One purpose of the barrier layer is to protect the electrodes and organic layers from damaging exposure to harmful species in the environment including moisture, vapor and/or gases, etc. The barrier layer may be deposited over, under or next to a substrate, an electrode, or over any other parts of a device including an edge. The barrier layer may comprise a single layer, or multiple layers. The barrier layer may be formed by various known chemical vapor deposition techniques and may include compositions having a single phase as well as compositions having multiple phases. Any suitable material or combination of materials may be used for the barrier layer. The barrier layer may incorporate an inorganic or an organic compound or both. The preferred barrier layer comprises a mixture of a polymeric material and a non-polymeric material as described in U.S. Pat. No. 7,968,146, PCT Pat. Application Nos. PCT/US2007/023098 and PCT/US2009/042829, which are herein incorporated by reference in their entireties. To be considered a “mixture”, the aforesaid polymeric and non-polymeric materials comprising the barrier layer should be deposited under the same reaction conditions and/or at the same time. The weight ratio of polymeric to non-polymeric material may be in the range of 95:5 to 5:95. The polymeric material and the non-polymeric material may be created from the same precursor material. In one example, the mixture of a polymeric material and a non-polymeric material consists essentially of polymeric silicon and inorganic silicon.

In some embodiments, at least one of the anode, the cathode, or a new layer disposed over the organic emissive layer functions as an enhancement layer. The enhancement layer comprises a plasmonic material exhibiting surface plasmon resonance that non-radiatively couples to the emitter material and transfers excited state energy from the emitter material to non-radiative mode of surface plasmon polariton. The enhancement layer is provided no more than a threshold distance away from the organic emissive layer, wherein the emitter material has a total non-radiative decay rate constant and a total radiative decay rate constant due to the presence of the enhancement layer and the threshold distance is where the total non-radiative decay rate constant is equal to the total radiative decay rate constant. In some embodiments, the OLED further comprises an outcoupling layer. In some embodiments, the outcoupling layer is disposed over the enhancement layer on the opposite side of the organic emissive layer. In some embodiments, the outcoupling layer is disposed on opposite side of the emissive layer from the enhancement layer but still outcouples energy from the surface plasmon mode of the enhancement layer. The outcoupling layer scatters the energy from the surface plasmon polaritons. In some embodiments this energy is scattered as photons to free space. In other embodiments, the energy is scattered from the surface plasmon mode into other modes of the device such as but not limited to the organic waveguide mode, the substrate mode, or another waveguiding mode. If energy is scattered to the non-free space mode of the OLED other outcoupling schemes could be incorporated to extract that energy to free space. In some embodiments, one or more intervening layer can be disposed between the enhancement layer and the outcoupling layer. The examples for interventing layer(s) can be dielectric materials, including organic, inorganic, perovskites, oxides, and may include stacks and/or mixtures of these materials.

The enhancement layer modifies the effective properties of the medium in which the emitter material resides resulting in any or all of the following: a decreased rate of emission, a modification of emission line-shape, a change in emission intensity with angle, a change in the stability of the emitter material, a change in the efficiency of the OLED, and reduced efficiency roll-off of the OLED device. Placement of the enhancement layer on the cathode side, anode side, or on both sides results in OLED devices which take advantage of any of the above-mentioned effects. In addition to the specific functional layers mentioned herein and illustrated in the various OLED examples shown in the figures, the OLEDs according to the present disclosure may include any of the other functional layers often found in OLEDs.

The enhancement layer can be comprised of plasmonic materials, optically active metamaterials, or hyperbolic metamaterials. As used herein, a plasmonic material is a material in which the real part of the dielectric constant crosses zero in the visible or ultraviolet region of the electromagnetic spectrum. In some embodiments, the plasmonic material includes at least one metal. In such embodiments the metal may include at least one of Ag, Al, Au, Ir, Pt, Ni, Cu, W, Ta, Fe, Cr, Mg, Ga, Rh, Ti, Ru, Pd, In, Bi, Ca alloys or mixtures of these materials, and stacks of these materials. In general, a metamaterial is a medium composed of different materials where the medium as a whole acts differently than the sum of its material parts. In particular, we define optically active metamaterials as materials which have both negative permittivity and negative permeability. Hyperbolic metamaterials, on the other hand, are anisotropic media in which the permittivity or permeability are of different sign for different spatial directions. Optically active metamaterials and hyperbolic metamaterials are strictly distinguished from many other photonic structures such as Distributed Bragg Reflectors (“DBRs”) in that the medium should appear uniform in the direction of propagation on the length scale of the wavelength of light. Using terminology that one skilled in the art can understand: the dielectric constant of the metamaterials in the direction of propagation can be described with the effective medium approximation. Plasmonic materials and metamaterials provide methods for controlling the propagation of light that can enhance OLED performance in a number of ways.

In some embodiments, the enhancement layer is provided as a planar layer. In other embodiments, the enhancement layer has wavelength-sized features that are arranged periodically, quasi-periodically, or randomly, or sub-wavelength-sized features that are arranged periodically, quasi-periodically, or randomly. In some embodiments, the wavelength-sized features and the sub-wavelength-sized features have sharp edges.

In some embodiments, the outcoupling layer has wavelength-sized features that are arranged periodically, quasi-periodically, or randomly, or sub-wavelength-sized features that are arranged periodically, quasi-periodically, or randomly. In some embodiments, the outcoupling layer may be composed of a plurality of nanoparticles and in other embodiments the outcoupling layer is composed of a pluraility of nanoparticles disposed over a material. In these embodiments the outcoupling may be tunable by at least one of varying a size of the plurality of nanoparticles, varying a shape of the plurality of nanoparticles, changing a material of the plurality of nanoparticles, adjusting a thickness of the material, changing the refractive index of the material or an additional layer disposed on the plurality of nanoparticles, varying a thickness of the enhancement layer, and/or varying the material of the enhancement layer. The plurality of nanoparticles of the device may be formed from at least one of metal, dielectric material, semiconductor materials, an alloy of metal, a mixture of dielectric materials, a stack or layering of one or more materials, and/or a core of one type of material and that is coated with a shell of a different type of material. In some embodiments, the outcoupling layer is composed of at least metal nanoparticles wherein the metal is selected from the group consisting of Ag, Al, Au, Ir, Pt, Ni, Cu, W, Ta, Fe, Cr, Mg, Ga, Rh, Ti, Ru, Pd, In, Bi, Ca, alloys or mixtures of these materials, and stacks of these materials. The plurality of nanoparticles may have additional layer disposed over them. In some embodiments, the polarization of the emission can be tuned using the outcoupling layer. Varying the dimensionality and periodicity of the outcoupling layer can select a type of polarization that is preferentially outcoupled to air. In some embodiments the outcoupling layer also acts as an electrode of the device.

It is believed that the internal quantum efficiency (IQE) of fluorescent OLEDs can exceed the 25% spin statistics limit through delayed fluorescence. As used herein, there are two types of delayed fluorescence, i.e. P-type delayed fluorescence and E-type delayed fluorescence. P-type delayed fluorescence is generated from triplet-triplet annihilation (TTA).

On the other hand, E-type delayed fluorescence does not rely on the collision of two triplets, but rather on the thermal population between the triplet states and the singlet excited states. Compounds that are capable of generating E-type delayed fluorescence are required to have very small singlet-triplet gaps. Thermal energy can activate the transition from the triplet state back to the singlet state. This type of delayed fluorescence is also known as thermally activated delayed fluorescence (TADF). A distinctive feature of TADF is that the delayed component increases as temperature rises due to the increased thermal energy. If the reverse intersystem crossing rate is fast enough to minimize the non-radiative decay from the triplet state, the fraction of back populated singlet excited states can potentially reach 75%. The total singlet fraction can be 100%, far exceeding the spin statistics limit for electrically generated excitons.

E-type delayed fluorescence characteristics can be found in an exciplex system or in a single compound. Without being bound by theory, it is believed that E-type delayed fluorescence requires the luminescent material to have a small singlet-triplet energy gap (ΔES-T). Organic, non-metal containing, donor-acceptor luminescent materials may be able to achieve this. The emission in these materials is often characterized as a donor-acceptor charge-transfer (CT) type emission. The spatial separation of the HOMO and LUMO in these donor-acceptor type compounds often results in small ΔES-T. These states may involve CT states. Often, donor-acceptor luminescent materials are constructed by connecting an electron donor moiety such as amino- or carbazole-derivatives and an electron acceptor moiety such as N-containing six-membered aromatic ring.

Devices fabricated in accordance with embodiments of the invention can be incorporated into a wide variety of electronic component modules (or units) that can be incorporated into a variety of electronic products or intermediate components. Examples of such electronic products or intermediate components include display screens, lighting devices such as discrete light source devices or lighting panels, etc. that can be utilized by the end-user product manufacturers. Such electronic component modules can optionally include the driving electronics and/or power source(s). Devices fabricated in accordance with embodiments of the invention can be incorporated into a wide variety of consumer products that have one or more of the electronic component modules (or units) incorporated therein. A consumer product comprising an OLED that includes the compound of the present disclosure in the organic layer in the OLED is disclosed. Such consumer products would include any kind of products that include one or more light source(s) and/or one or more of some type of visual displays. Some examples of such consumer products include a flat panel display, a curved display, a computer monitor, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a cell phone, tablet, a phablet, a personal digital assistant (PDA), a wearable device, a laptop computer, a digital camera, a camcorder, a viewfinder, a micro-display that is less than 2 inches diagonal, a 3-D display, a virtual reality or augmented reality display, a vehicle, a video walls comprising multiple displays tiled together, a theater or stadium screen, and a sign. Various control mechanisms may be used to control devices fabricated in accordance with the present invention, including passive matrix and active matrix. Many of the devices are intended for use in a temperature range comfortable to humans, such as 18 C to 30 C, and more preferably at room temperature (20-25 C), but could be used outside this temperature range, for example, from −40 C to 80 C.

The materials and structures described herein may have applications in devices other than OLEDs. For example, other optoelectronic devices such as organic solar cells and organic photodetectors may employ the materials and structures. More generally, organic devices, such as organic transistors, may employ the materials and structures.

In some embodiments, the OLED has one or more characteristics selected from the group consisting of being flexible, being rollable, being foldable, being stretchable, and being curved. In some embodiments, the OLED is transparent or semi-transparent. In some embodiments, the OLED further comprises a layer comprising carbon nanotubes.

In some embodiments, the OLED further comprises a layer comprising a delayed fluorescent emitter. In some embodiments, the OLED comprises a RGB pixel arrangement or white plus color filter pixel arrangement. In some embodiments, the OLED is a mobile device, a hand held device, or a wearable device. In some embodiments, the OLED is a display panel having less than 10 inch diagonal or 50 square inch area. In some embodiments, the OLED is a display panel having at least 10 inch diagonal or 50 square inch area. In some embodiments, the OLED is a lighting panel.

In some embodiments of the emissive region, the emissive region further comprises a host.

In some embodiments, the compound can be an emissive dopant. In some embodiments, the compound can produce emissions via phosphorescence, fluorescence, thermally activated delayed fluorescence, i.e., TADF (also referred to as E-type delayed fluorescence), triplet-triplet annihilation, or combinations of these processes.

The OLED disclosed herein can be incorporated into one or more of a consumer product, an electronic component module, and a lighting panel. The organic layer can be an emissive layer and the compound can be an emissive dopant in some embodiments, while the compound can be a non-emissive dopant in other embodiments.

The organic layer can also include a host. In some embodiments, two or more hosts are preferred. In some embodiments, the hosts used maybe a) bipolar, b) electron transporting, c) hole transporting or d) wide band gap materials that play little role in charge transport. In some embodiments, the host can include a metal complex. The host can be an inorganic compound.

### Combination With Other Materials

The materials described herein as useful for a particular layer in an organic light emitting device may be used in combination with a wide variety of other materials present in the device. For example, emissive dopants disclosed herein may be used in conjunction with a wide variety of hosts, transport layers, blocking layers, injection layers, electrodes and other layers that may be present. The materials described or referred to below are non-limiting examples of materials that may be useful in combination with the compounds disclosed herein, and one of skill in the art can readily consult the literature to identify other materials that may be useful in combination.

Various materials may be used for the various emissive and non-emissive layers and arrangements disclosed herein. Examples of suitable materials are disclosed in U.S. Patent Application Publication No. 2017/0229663, which is incorporated by reference in its entirety.

### Conductivity Dopants:

A charge transport layer can be doped with conductivity dopants to substantially alter its density of charge carriers, which will in turn alter its conductivity. The conductivity is increased by generating charge carriers in the matrix material, and depending on the type of dopant, a change in the Fermi level of the semiconductor may also be achieved. Hole-transporting layer can be doped by p-type conductivity dopants and n-type conductivity dopants are used in the electron-transporting layer.

### HIL/HTL:

A hole injecting/transporting material to be used in the present invention is not particularly limited, and any compound may be used as long as the compound is typically used as a hole injecting/transporting material.

### EBL:

An electron blocking layer (EBL) may be used to reduce the number of electrons and/or excitons that leave the emissive layer. The presence of such a blocking layer in a device may result in substantially higher efficiencies, and or longer lifetime, as compared to a similar device lacking a blocking layer. Also, a blocking layer may be used to confine emission to a desired region of an OLED. In some embodiments, the EBL material has a higher LUMO (closer to the vacuum level) and/or higher triplet energy than the emitter closest to the EBL interface. In some embodiments, the EBL material has a higher LUMO (closer to the vacuum level) and or higher triplet energy than one or more of the hosts closest to the EBL interface. In one aspect, the compound used in EBL contains the same molecule or the same functional groups used as one of the hosts described below.

### Host:

The light emitting layer of the organic EL device of the present invention preferably contains at least a metal complex as light emitting material, and may contain a host material using the metal complex as a dopant material. Examples of the host material are not particularly limited, and any metal complexes or organic compounds may be used as long as the triplet energy of the host is larger than that of the dopant. Any host material may be used with any dopant so long as the triplet criteria is satisfied.

### HBL:

A hole blocking layer (HBL) may be used to reduce the number of holes and/or excitons that leave the emissive layer. The presence of such a blocking layer in a device may result in substantially higher efficiencies and/or longer lifetime as compared to a similar device lacking a blocking layer. Also, a blocking layer may be used to confine emission to a desired region of an OLED. In some embodiments, the HBL material has a lower HOMO (further from the vacuum level) and or higher triplet energy than the emitter closest to the HBL interface. In some embodiments, the HBL material has a lower HOMO (further from the vacuum level) and or higher triplet energy than one or more of the hosts closest to the HBL interface.

### ETL:

An electron transport layer (ETL) may include a material capable of transporting electrons. The electron transport layer may be intrinsic (undoped), or doped. Doping may be used to enhance conductivity. Examples of the ETL material are not particularly limited, and any metal complexes or organic compounds may be used as long as they are typically used to transport electrons.

### Charge Generation Layer (CGL)

In tandem or stacked OLEDs, the CGL plays an essential role in the performance, which is composed of an n-doped layer and a p-doped layer for injection of electrons and holes, respectively. Electrons and holes are supplied from the CGL and electrodes. The consumed electrons and holes in the CGL are refilled by the electrons and holes injected from the cathode and anode, respectively; then, the bipolar currents reach a steady state gradually. Typical CGL materials include n and p conductivity dopants used in the transport layers.

OLEDs and similar display components often are used to fabricate larger-scale displays, such as OLED display panels, which may further be incorporated into other products. Conventional display panels receive a display signal from a source external to the display panel but which may be integrated into a common device with the display panel, such as a network port or other communication interface that may provide streamed video content, external devices such as computers, cameras, phones, media players, and the like, or any other source of image or video data. The display panel typically includes or is in signal communication with a display processor that converts the display signal into image data that can be used by the display panel to generate the image defined by the display signal.

Embodiments disclosed herein provide adaptive display panels that use one or more processors to analyze the incoming display signal and make adjustments to the operational behavior of the display panel based on characteristics of the incoming display signal. In some cases adjustments to the operational behavior of the display panel may be made based on the overall image being rendered on the display for each frame being rendered. This is different from some displays that are illuminated in zones or regions where the luminance of each zone can be independently adjusted. Using emissive OLED technology each pixel can be independently adjusted, but the adjustments to the operational behavior of the display panel as disclosed herein may be based on characteristics of the overall incoming display signal, such as by sampling all the image information for each frame being rendered. For example, operation of the display panel may be adjusted to change a white balance or other color balance, change a display frame rate, or change one or more other operational behaviors of the display panel, in response to characteristics of the incoming display signal such as the average or peak luminance, the presence of static content such as an icon, the degree or extent of movement, or other characteristics as disclosed herein.

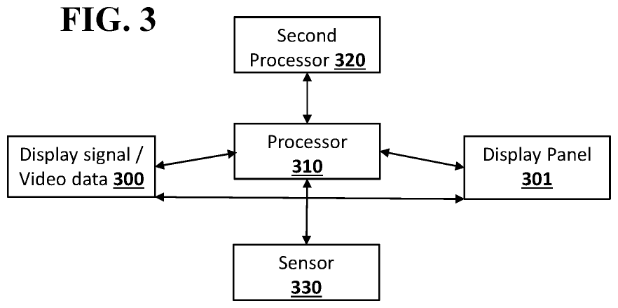

FIG. 3 shows an example device or system incorporating an adaptive display as disclosed herein. The components shown in FIG. 3 may be incorporated into a single device, such as a display, a phone, a television or other monitor, or the like, or they may be implemented as separate devices such as a display in signal communication with a processing device such as a set-top box, a cloud service, or the like. The system includes a display panel 301 in signal communication with a first processor 310, which may be referred to as a display processor, video processor, imaging processor, or the like. The display panel 301 may be an OLED display, microLED display, quantum dot display, LCD display, or any other suitable architecture or combination thereof.

The processor 310 may provide conventional signal analysis and processing of display signals 300 as is known in the art, separately from or in addition to the additional processing and techniques disclosed herein. The display signal 300 may be provided by any suitable source of image data as previously disclosed, and may include still images, video, 3D data, or combinations thereof. The display signal 300 also may be referred to herein as an input display signal or input signal to indicate that it is received as the original display data, i.e., prior to any processing by the processors disclosed herein.

A second processor 320, which also may be referred to herein as an edge processor, supplemental processor, AI processor, or the like, may provide additional processing of the display signal. The additional processing may be performed before, after, or concurrently with processing provided by the first processor 310. The second processor 320 may receive the input display signal 300 either directly or from the first processor 310 or another component of the system. More generally, although FIG. 3 shows an example arrangement in which the input display signal 300 is received initially by the first processor 310, the input display signal may be received by any suitable component of the system as disclosed herein sequentially or concurrently. The second processor 320 may specifically analyze the display signal 300 to identify one or more characteristics of the display signal, based upon which the second processor 320 may generate display panel behavior adjustment data that indicates one or more adjustments to be made to operational behavior of the display panel. The second processor may use machine learning or artificial intelligence techniques and algorithms such as a neural network, a convolution neural network, a recurrent neural network, a radial basis function neural network, a multilayer perceptron, a deep belief network, or any other suitable algorithm, or any combination thereof, to develop appropriate behavior adjustment data in response to various display signal characteristics. The second processor 320 may be a separate physical processor contained in the display or other device and connected in signal communication with the first display processor 310, or the functionality described with respect to the second processor 320 may be incorporated into the display processor 310. More generally, the functions disclosed herein with respect to the first and second processors may be performed by one or more distinct physical processors, in any desired arrangement of functionality between the one or more physical processors. The second processor also may be provided by a remote device such as a cloud-based service, or combination of a remote device and a local processor. For example, where the display signal is a video signal being streamed from a remote provider, the functionality disclosed herein with respect to the second processor and the machine learning system implemented thereon may be provided by the remote system, a local processor, or a combination thereof. Some functions may be performed locally, for example to reduce the latency associated with communication to and from the remote platform. In some embodiments, it may be preferred for the second processor and the associated machine learning system to be implemented entirely locally, for example on the same device as the display panel, to eliminate such latency, especially where real-time processing by the second processor is desired.

Conventional use of artificial intelligence techniques in image processing typically is limited to approaches such as interpreting image data in order to act on the image itself (e.g. facial recognition), or else to adjust or compensate the image data based on its content. For example, various AI approaches may modify image data such as a display signal 300 to improve the resolution, sharpness, color, brightness or contrast, or other attributes of the display signal. As a specific example, phone cameras and other digital cameras may be configured to adjust an image or video during the capture process to make the image brighter, sharper, or the like. The interpretation of the image data may consider each overall image frame by frame and the adjustment made to the display panel may also be made for each image frame being rendered by the display.

In contrast, embodiments disclosed herein interpret the display signal, for example using machine learning techniques such as convoluted neural networks, to adjust the performance of the display panel rendering the image itself. This may allow a system such as the one shown in FIG. 3 to reduce display power consumption of the panel, improve the panel lifetime, reduce image sticking, and the like, without detracting from the visual perception of the image being shown on the display panel.

As previously disclosed, the second processor 320 may implement one or more machine learning systems that has been previously trained to interpret image data in the display signal 300. For example, the processor may implement a multi-layer convolutional neural network that has been trained to recognize specific shapes, objects, scenes, and the like, and/or other characteristics of the display signal such as luminance, the presence of movement and/or static objects such as icons, a level of detail, the presence of faces or other recognizable features, the presence of artificial image data such as computer-generated images or video data, or the like. Training of the machine learning system may be performed before the device is sold or otherwise provided to an end user. Alternatively or in addition, the machine learning system may be configured to learn initially or to continue learning as it is used by an end user, for example in response to actions performed by the end user, data collected from the user such as via prompts, surveys, or the like, or via automatic feedback obtained by measuring performance of the display panel during operation. Based on the trained machine learning system and the display signal 300, the second processor 320 generates display panel behavior adjustment data which indicates one or more adjustments to operational behavior of the display panel.

The second processor 320 may provide display panel behavior adjustment data that indicates appropriate adjustments to behavior of the display panel to the first processor 310, directly to the display panel 301, or a combination thereof. Accordingly, either the first processor 310, the second processor 320, or both processors may adapt behavior of the display panel in response to the adjustment data generated by the second processor 320.

In some embodiments, the system may include one or more sensors 330. The sensor may be used, for example, to measure ambient luminance, perform gaze or eye tracking, measure other ambient environmental data such as ambient temperature, scan barcodes, QR codes, or other machine-readable media, or the like. Input from the sensor 330 may be provided to the second processor 320, where it may be used to generate the display panel behavior adjustment data, either separately from or in addition to data obtained from the display signal 300 itself. Other examples of sensors that may be used include accelerometers, air humidity sensors, barcode/QR sensors, barometers, fingerprint sensors, GPS, gyroscopes, Hall sensors, magnetometers, proximity sensors, thermometers and touchscreen sensors. The machine learning system implemented by the second processor may be trained on data from any sensors included in the system in the same manner as it is trained on image data in the display signal 300.

The machine learning system may be trained to accomplish specific objectives with regard to performance of the display panel. For example, performance of the display panel may be adjusted to improve its performance based on lowering power consumption or extending display lifetime (for example, to reducing image sticking) while not degrading the visual experience of the user. For example, the machine learning system may be trained to recognize signs, scenes, images or the like in the display signal that can be used to optimize the display performance while maintaining an optimum visual image to the user viewing the display. This may be done through suitable training procedures associated with the machine learning system and algorithms implemented by the second processor, for example, by training the system to improve the desired characteristics of the display using a set of training data. The training data may be used to tune parameters of the machine learning system, which then can be applied to new image data in the display signal 300.

The display signal 300 may be analyzed by the first and second processors as an image signal, a video, signal, or a combination thereof, with the machine learning system implemented by the second processor being trained on the same type(s) of data. For example, where the display signal contains video data, it may be analyzed one frame at a time, in segments containing multiple frames, as video segments, or any combination thereof. The analysis and generation of the display panel behavior adjustment data by the second processor 320 may be performed in real-time or essentially real-time, i.e., such that no caching of the display signal is required and the display signal may be analyzed as it is received. In this case there may be little or no apparent lag between receipt of the display signal and presentation of the associated image data by the display panel.

For example, the following criteria may be interpreted from image data in the display signal and the display behavior adjusted based on this interpretation:

Fast moving objects—if fast moving objects are identified in video data in the display signal, the display panel behavior adjustment data may indicate that the display frame rate of the display panel should be increased. Similarly, the display panel may be operated at a lower display frame rate unless and until fast-moving objects are detected in the display signal. For example, if the display panel is capable of running at 240 Hz, it may normally be set to operate at 120 Hz to reduce power consumption, and only operated at the higher rate when fast moving images are detected in the display signal. This may allow for the display panel to be operated at relatively very low frame rates where the display signal includes video data with little or no movement, such as still images, slowly-changing images, or the like, even down to rates as low as 1 Hz with an appropriate backplane configuration designed to provide sufficiently-low leakage to support such the frame rate such as low-leakage low-temperature polycrystalline oxide (LTPO) technology display arrangements. As used herein, a “fast moving object” in video data refers to one that would appear in more than one pixel at the same time due to the frame rate of the display panel. For example, for a display panel having a maximum clock speed (refresh rate) of 240 Hz, a “fast moving” object would require the image to change every 0.004 seconds or less.

High brightness objects—in response to detecting objects or areas of video with relatively high brightness, the display panel behavior adjustment data may indicate that the overall display luminance should be reduced so that high brightness objects stand out, but the total power used by the display does not become too high. That is, the relative apparent brightness of the bright objects may be retained (from the perspective of a viewer), while avoiding the associated increase in brightness that would be expected from conventional processing of the same display signal. As used herein, a “high brightness” object may refer to one that requires at least a threshold percentage of the maximum brightness of the display panel, such as 90%, 95%, 98%, or 100%. Alternatively, a “high brightness” object may refer to an object that is bright relative to the surrounding image, such as an image showing only a moon in an otherwise dark, clear sky, for example where the object provides the majority of brightness of the image as a whole. A “high brightness” also may be measured as an absolute brightness value, such as 500 nits or more, 1000 nits or more, 1500 nits or more, or the like.

Bright and/or static icons—if image data includes static components, behavior of the display panel may be adjusted by decreasing display brightness, for example by 10% or more, and/or by lowering the blue content and/or white point of the panel, for example by 10% or more. This may prevent image sticking or “burn-in,” i.e., a visible artifact of the icon being visible after it is no longer being displayed by the panel. An “icon” in this context may refer to any static component that is included in video data for an extended period of time, such as a watermark, channel indicator or chyron, ticker background, clock, or the like.

Highly detailed images—if the second processor identifies images having a higher degree of detail, the display resolution may be increased, for example by a factor of 1.25, 1.5, 1.75, 2, or more, preferably in a linear dimension. For displays with relatively high native resolutions such as 4K or 8K displays, the display panel may be operated normally at a lower resolution to reduce power consumption and at the higher resolution(s) only when highly-detailed images or other similar characteristics are identified. Similarly, if the display signal contains relatively little detail, the regular display resolution may be reduced by a factor of 1.25, 1.5, 1.75, 2, or more. As used herein, a “highly detailed” or “high detail” image refers to one in which the image changes within each physical pixel so that higher resolution and/or smaller pixels are required to render the correct level of detail. For example, high detail is often required to display Kanji text, while a fog-filled scene or a plain white wall are not high detail images.

Faces—image data containing faces may benefit from use of the best possible white point, color gamut and blue content, since human viewers typically are very sensitive to discoloration, distortion, or other alteration of human faces. Typically, the “best” natural rendering is shown in natural or warmer white color, while higher-detail images are rendered in cooler white light.

Artificial images—Artificial images and video, such as computer-generated images, may benefit from reduced blue saturation and white point could be reduced, as well as luminance, resolution and/or frame rate. This is because images not occurring in or based on real-world scenes typically use an artificial color gamut, thus allowing for adjustment of blue content to reduce power and increase lifetime without causing the image to look incorrect or unappealing to a human viewer.

In general, it may be desirable to operate the display panel with the lowest-power behavior that is suitable for the image data being displayed. The display panel behavior may be altered as needed based on data provided by the second processor, which may result in a higher-power or lower-power mode for the specific image data being displayed from the display signal, which still may be the lowest-power mode that is suitable (as determined by the second processor) for the image being displayed. For example, where the display panel behavior adjustment data indicates an increase in frame rate, the resulting higher-frame rate mode may still be the lowest-power mode identified as appropriate for the display by the second processor.

As previously disclosed, changes to the operational behavior of the display panel also may be made based on data obtained from one or more sensors, such as the sensor 330 shown in FIG. 3. For example, the luminance of the display panel may be increased and/or the white point may be adjusted toward the green spectrum in high ambient lighting conditions, such as may be detected by a light sensor or equivalent. As another example, the green content may be removed from the white point for images viewed at night or other low-light conditions to maintain or enable dark adaption of the viewer's eyes. Such operation may be similar to the use of night vision white levels in cockpit displays and similar applications. Such an approach may be useful in similar situations, in automotive or display functions at night, or in other low ambient light settings.

In some embodiments, it may be possible to adjust the display viewing angle electronically. For example, some display panels include micromirrors or other components that allow for the effective viewing angle of the display to be modified. In such devices, the display panel behavior adjusted by the second processor may include the effective viewing angle of the display panel. Typically a narrow viewing angle may be desired to reduce overall power consumption, so images not being shared by multiple users (for example as detected by one or more other sensors 330) may use a reduced viewing angle. If the sensor(s) 330 detect multiple viewers, the second processor may adjust the display panel behavior to use a larger effective viewing angle to maintain an acceptable display and experience for all viewers.

As another example, the color gamut may be adjusted based on image interpretation by the second processor. Less-saturated colors may be used to reduce power consumption where the second processor determines that fewer saturated colors are required to adequately or acceptably display a particular image. To enable such an approach, color gamut adjustable displays may include more than three non-white subpixel colors and/or include independently-addressable stacked LEDs, OLEDs, or other similar imaging components where each stack can be addressed. That is, the OLEDs may be arranged in a stack and connected in series with one other in the vertical (z) plane of the display panel, perpendicular to the backplane, while still each being addressable independently of the others. In this arrangement, each stack is also independently addressable as in a conventional display panel.

Other specific, non-limiting examples of adjustments that may be made to operational behavior of the display include lowering the blue saturation at high luminance, lowering the white point color temperature at high luminance, lowering the blue saturation if the image includes bright and/or static icons, reducing a display frame rate from nominal value for images where content has low movement from frame to frame, increasing the display frame rate from nominal value for images where content has high movement from frame to frame, increasing the green to blue ratio of images in the presence of high ambient illumination, and reducing the luminance when the video data includes fixed icons. Specific examples of display panel behavior adjustments that may be made in response to specific display signal characteristics include, but are not limited to lowering a blue saturation based on a luminance being over a threshold, lowering a white point color temperature based on a luminance being over a threshold, lowering a blue saturation based on a detection of a static icon, reducing a display frame rate based on video content having movement from frame to frame below a threshold, increasing a display frame rate based on video content having movement from frame to frame above a threshold, increasing a display resolution based on video content having a detail level over a threshold, adjusting a white point color temperature, a color gamut, a blue content, or a combination thereof based on detecting one or more faces, and decreasing a blue saturation, a white point color temperature, or a combination thereof based on detecting artificial image data. More generally, adjustments to display behavior as disclosed herein may include adjusting any of white point color temperature, color gamut, display frame rate, green-to-blue, red-to-green, or any other suitable color ratio, luminance, and blue, green, and/or red saturation.

For display signal characteristics disclosed herein that include a relative measure of the characteristic, such as “high brightness,” “fast moving”, “high detail”, and the like, where a specific definition is not provided or where the characteristic is inconsistent with the examples disclosed above, the associated characteristic may be considered relative to surrounding data in the display signal. For example, if the difference in the characteristic between a particular portion of video data and surrounding portions of the video that occur before and after the portion being analyzed exceeds a threshold, that portion may be considered to meet the relative criteria. The threshold also may be applied on a frame-by-frame basis, segment-by-segment, or any other available and suitable delineation of image data that is available to the system. The threshold may be selected or may be determined by the machine learning system based on training data as previously disclosed. Examples of suitable thresholds include a 10% difference, 20% difference, 30% difference, or more. As a specific example, a portion of video data may be considered “high brightness” if it is at least 10% brighter than the immediately preceding segment of the same video data in the display signal, or if it is at least 10% brighter than a running average taken across the same video as the analyzed portion. Similarly, the degree to which a selected operational behavior of the display is adjusted may be statically set or may be determined by the machine learning system either during a training phase or during operation of the display. Examples of suitable relative changes to a particular behavior include 10%, 20%, 25%, 50%, 75%, and 100% changes relative to the unchanged values, but the embodiments disclosed herein are not limited to these particular values and any value selected by the machine learning system or otherwise set by the system may be used. The specific comparison, portion of image data, and threshold may be determined experimentally, chosen by a developer, or determined during training and/or operation of the machine learning system implemented by the second processor.

Adjustments made to a display panel based on display panel behavior adjustment data as disclosed herein are different from, and occur independently of, conventional adjustments to display panel operation such as brightness, tint, and contrast settings that may be selected by a user. For example, regardless of the any adjustments made to display panel behavior as disclosed herein (which are based on display panel behavior adjustment data generated by the second processor), a user may independently adjust the visual settings of the display panel to increase or decrease the total overall brightness, contrast, etc. Such adjustments occur at the user level, not at the display signal processing level disclosed herein. Accordingly, user-available adjustments are not considered to be changes to the behavior of a display panel as disclosed herein. Further, user-level adjustments cannot be made in response to display panel behavior adjustment data as disclosed herein, since those settings take effect regardless of the content of any particular display signal being processed by the processors and cannot affect such internal processing.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

1. A device comprising:
a display panel;
a first processor in signal communication with the display panel, the first processor configured to receive an input display signal and provide image data to the display panel; and
a second processor configured to receive the input display signal and provide display panel behavior adjustment data to the display processor based on the input display signal, the display panel behavior adjustment data indicating a first adjustment to an operational behavior of the display panel based on a first characteristic of the input display signal;
wherein the first processor, the second processor, or a combination thereof is configured to alter the operational behavior of the display panel based on the display panel behavior adjustment data.

2. The device of claim 1, wherein the first characteristic of the input display signal is selected from the group consisting of: brightness, frame rate, color gamut, color saturation, hue, white point and resolution.

3. The device of claim 1, wherein the first characteristic of the input display signal is selected from the group consisting of: a movement speed of an object; a relative brightness of an object; a static icon; a degree of detail; a face; and an artificial image.

4. The device of claim 1, wherein the first adjustment to the operational behavior of the display panel comprises changing one or more selected from a group consisting of:
a white point color temperature;
a color gamut;
a display frame rate;
a green to blue ratio or a red to green ratio;
a luminance; and
a blue saturation.

5. The device of claim 4, wherein the first adjustment to the operational behavior of the display panel based on the first characteristic of the input display signal comprises one or more selected from a group consisting of:
lowering a blue saturation based on a luminance being over a threshold;
lowering a white point color temperature based on a luminance being over a threshold;
lowering a blue saturation based on a detection of a static icon;
reducing a display frame rate based on video content having movement from frame to frame below a threshold;
increasing a display frame rate based on video content having movement from frame to frame above a threshold;
increasing a display resolution based on video content having a detail level over a threshold;
adjusting a white point color temperature, a color gamut, a blue content, or a combination thereof based on detecting one or more faces; and
decreasing a blue saturation, a white point color temperature, or a combination thereof based on detecting artificial image data.

6. The device of claim 1, wherein the second processor is an artificial intelligence processor.

7. The device of claim 6, wherein the artificial intelligence processor is configured to implement a machine learning system that applies a machine learning algorithm to the input display signal to generate the image adjustment data.

8. The device of claim 7, wherein the machine learning system comprises a neural network, a convolution neural network, a recurrent neural network, a radial basis function neural network, a multilayer perceptron, a deep belief network, or a combination thereof.

9. The device of claim 1, further comprising:
an ambient light sensor;
wherein the first processor is further configured to adjust the operational behavior of the display panel based on a brightness of ambient light detected by the ambient light sensor.

10. The device of claim 1, further comprising:
a gaze detection sensor configured to identify a direction of gaze of a viewer of the display;
wherein the first processor is further configured to adjust the operational behavior of the display panel based on the direction of gaze detected by the gaze detection sensor.

11. The device of claim 1, wherein the gaze detection sensor comprises one or more components selected from the group consisting of: an infrared (IR) sensor, a still camera, and a video camera.

12. The device of claim 1, wherein the display panel comprises an organic light emitting diode (OLED) display, a light emitting diode (LED) or micro-LED display, a quantum dot-based display, a liquid crystal display (LCD), or a combination thereof.

13. The device of claim 12, wherein the display panel comprises an OLED display, and wherein the display panel behavior adjustment data is based on the overall input display signal over the entire active area of the display panel.

14. The device of claim 1, wherein the first processor and/or the second processor comprises a plurality of physical computer processors.

15. The device of claim 1, wherein the second processor is the same processor as the first processor.

16. A method comprising:
receiving, by a first processor in a display device, an input display signal;
generating, by a second processor in the display device, display panel behavior adjustment data, the display panel behavior adjustment data indicating a first adjustment to an operational behavior of a display panel based on a first characteristic of the input display signal;
providing the display panel behavior adjustment data to the first processor;
adjusting, by the first processor, the operational behavior of the display panel based on the display panel behavior adjustment data; and
displaying, by the display panel, the input display signal.

17. The method of claim 16, wherein the first characteristic of the input display signal is selected from a group consisting of: brightness, frame rate, color gamut, white point and resolution.

18. The method of claim 16, wherein the first characteristic of the input display signal is selected from the group consisting of: a movement speed of an object; a relative brightness of an object; a static icon; a degree of detail; a face; and an artificial image.

19. (canceled)

20. The method of claim 16, wherein generating the display panel behavior adjustment data comprises applying a machine learning algorithm to the input display signal.

21-25. (canceled)

26. A consumer electronic device comprising:
a display panel;
a first processor in signal communication with the display panel, the first processor configured to receive an input display signal and provide image data to the display panel; and
a second processor configured to receive the input display signal and provide display panel behavior adjustment data to the display processor based on the input display signal, the display panel behavior adjustment data indicating a first adjustment to an operational behavior of the display panel based on a first characteristic of the input display signal;
wherein the first processor, the second processor, or a combination thereof is configured to alter the operational behavior of the display panel based on the display panel behavior adjustment data; and
wherein the consumer electronic device is at least one type selected from the group consisting of: a flat panel display, a curved display, a computer monitor, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a cell phone, tablet, a phablet, a personal digital assistant (PDA), a wearable device, a laptop computer, a digital camera, a camcorder, a viewfinder, a micro-display that is less than 2 inches diagonal, a 3-D display, a virtual reality or augmented reality display, a vehicle, a video walls comprising multiple displays tiled together, a theater or stadium screen, and a sign.
